(19) United States
(12) Patent Application Publication
(10) Pub. No.: US 2005/0197981 A1
(43) Pub. Date: Sep. 8, 2005

(54) Method for identifying unanticipated changes in multi-dimensional data sets

(76) Inventor: Clifton W. Bingham, West Lafayette, IN (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/759,023

(22) Filed: Jan. 20, 2004

(51) Int. Cl. G06E 1/00

(52) U.S. Cl. 706/20

(57) ABSTRACT

Unusual or unanticipated changes in multi-dimensional data sets (e.g., time series of image data) are identified using a vector prediction process. A plurality of artificial neural networks are trained to predict values of a subset of a multi-dimensional data set from a second subset of the multi-dimensional data sets. The artificial neural networks are then used to predict anticipated values for the same data used in training. Substantial differences between the anticipated and actual values represent an unanticipated change.

### BACKGROUND OF THE INVENTION

I. Field of the Invention

The disclosed method is directed to change detection in multi-dimensional data sets using neural networks. Specifically, the method disclosed herein utilizes data mining techniques, i.e., the application of the data under analysis to artificial neural networks for training thereof, whereby the artificial neural networks produce anticipated or expected values for a subset of the data and identifies unusual changes in the actual subset of the data.

II. Description of the Prior Art

Detecting changes based on a sequence of multi-dimensional data sets, e.g., overhead imagery, has been studied for some time. Early approaches using pixel-by-pixel image differencing used intensity scaling, followed by differencing, to identify changes. However, such a simple approach is useful only when no uninteresting changes occur. In wide area overhead imagery, this is not the case. Two pictures of the same location taken at different times of the year will be quite different, but most of the changes are a result of natural effects.

The imagery and vision communities have a long history of work on change detection. Change detection work falls into two categories: change vector analysis and pixel-level comparison. Change vector analysis requires developing a model of what should be in an image (e.g., a vector diagram of buildings and roads). The actual image is then compared with the diagram and differences are highlighted. The necessity of constructing a vector diagram of what should be found in a region appears to pose a high overhead and would limit this technique to a few locations important enough to justify constructing a diagram.

Change vector analysis is dependent on the diagram capturing the types of changes of interest. It requires pre-defining what is, and is not, important. An alternative is to directly compare the images. Earlier research in direct image comparisons suffered from an inability to filter uninteresting changes. A simple differencing can be foiled by changes in lighting intensity. Better threshold formulation and scaling techniques have been developed, but these still face problems with environmental changes.

One approach is to model the expected spectral values for certain known (interesting items) or explicitly model background noise. Artificial neural networks have been applied to the change detection problem, specifically using images and land use category “training data” to identify changes in land cover. These techniques still require considerable manual effort to define what is or is not interesting. In addition, this leaves the possibility that a pre-conceived notion of what is interesting may be wrong.

### SUMMARY OF THE INVENTION

To overcome the shortcomings of the prior art in identifying interesting or unusual changes in multi-dimensional data sets, a model is constructed which is based solely on what actually appears in the data set. An anticipated change is based on what is common, an unusual or unanticipated change is simply one that occurs infrequently.

According to one aspect of the method of the present invention, unanticipated changes in a multi-dimensional data set are detected by selecting a subset of the multi-dimensional data set, partitioning each data set of the subset into a plurality of locations, where the locations are sized in accordance with known or anticipated features of the data, assigning a vector to each of the plurality of locations in each data set of the subset, the vector including a plurality of scalar components, estimating from at least one of the data sets at least one expected vector for each of the plurality of locations, calculating a vector of expected ranges for each of the plurality of locations from the at least one expected vector, and comparing a vector assigned to each of the plurality of locations of one of the data sets to the vector of expected ranges of the corresponding location and identifying a location as having an unanticipated change when a predetermined number of the scalar components of the vector assigned to each of the plurality of locations exceeds the expected range in the corresponding vector of expected ranges.

### BRIEF DESCRIPTION OF THE DRAWINGS

FIGS. 1A-1B are illustrations of overhead images demonstrating unanticipated changes as identified by the method of the present invention:

FIG. 2 is a block diagram of the formation of vectors as utilized by the method of the present invention;

FIG. 3 is a nodal diagram of an artificial neural network as implemented by the invention of the present invention; and

FIG. 4 is a flow chart of the method of the present invention.

### DETAILED DESCRIPTION OF THE PREFERRED EMBODIMENTS

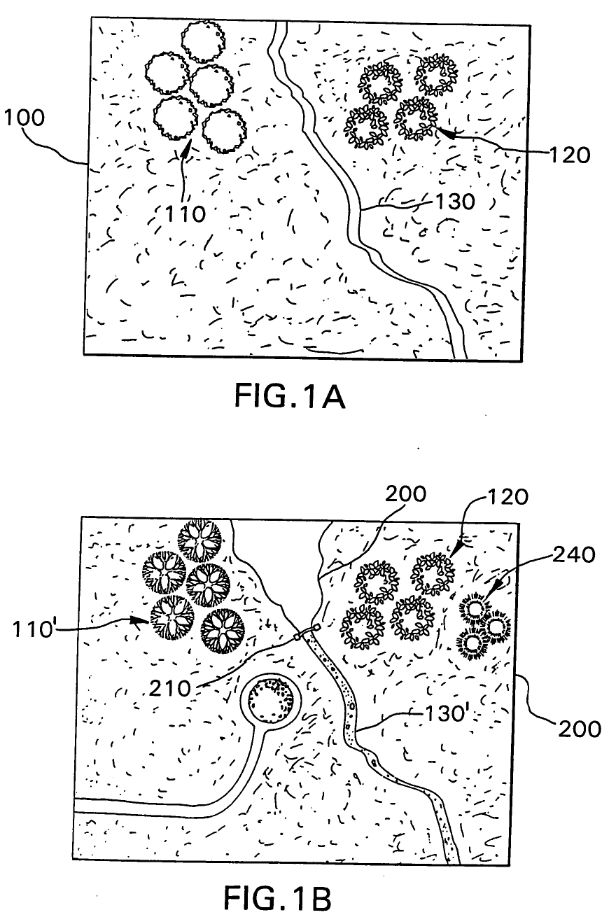

General objects of the method of the present invention are best understood by first considering the multi-dimensional data sets of FIGS. 1A and 1B, presented as images 100 and 200, respectively. Whereas, images 100, 200 are shown as isolated data sets, in general, the images will constitute a subset of a larger set of multi-dimensional data. Moreover, in exemplary embodiments of the subject method, the individual data sets of the multi-dimensional data set, of which images 100 and 200 are examples, are correlated by at least one predetermined criterion, such as time.

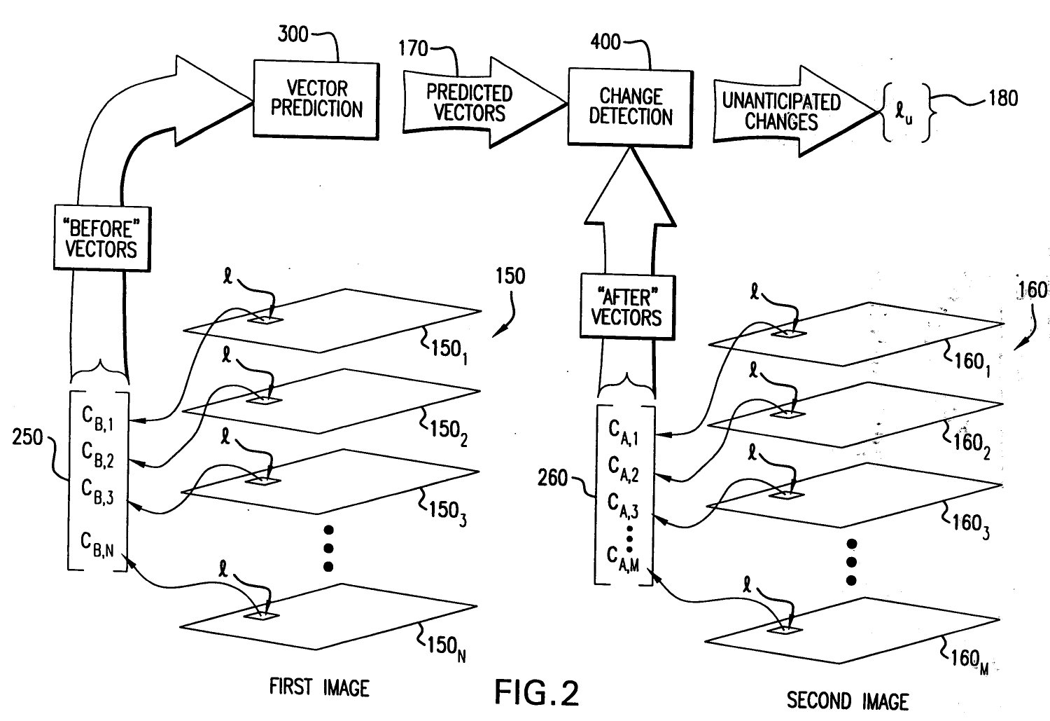

In a non-limiting exemplary embodiment of the present invention, images 100, 200 of FIGS. 1A and 1B, respectively, are each a two-dimensional array of pixels. Each pixel represents a measurement of a physical quantity such as electromagnetic spectral intensity at a particular wavelength. As will be shown in FIG. 2 and further discussed in relation thereto, pixels can be spatially grouped together in a plurality of locations and each location may include pixels from different views of the same location. However, for purposes of the present discussion, we will assume that images 100, 200 include data from different views for each location of the image in sufficient quantity to execute the method of the present invention.

For the following discussions of FIGS. 1A and 1B, reference will be made to image 100 as the “before” image and to image 200 as the “after” image. Thus, the images 100, 200 are correlated in time, i.e., the “before” image 100 was acquired prior to the acquisition of the “after” image 200. Whereas, in this example, the correlation of images is in units of time, the images may be correlated by another criterion, such as angular radiance.

“Before” image 100 is an overhead still image displaying several prominent features of interest. A first feature is stand of trees 110, which is separated from a second stand of trees 120 by a stream 130.

“After” image 200 is an overhead still image of the same region of space as was presented in “before” image 100. As previously mentioned, “after” image 200 was acquired later in time (perhaps, even years) than the acquisition of “before” image 100. The method of the present invention distinguishes between features of the images that are unusual or unanticipated in view of trends in the image data itself, as opposed to identifying differences in images based on preconceived definitions of what might be considered unusual.

For purposes of the present discussion, assume that “before” image 100 was acquired during the late Spring season and that “after” image 200 was acquired in late Autumn. As previously stated, the separation in time may be a number of years, but a distinction between the two images lies in that the “before” image 100 was acquired during a season of warmth, wherein plant life flourishes and “after” image 200 was acquired during a cooler season, wherein plant life begins to go into dormancy. Thus, it would be reasonable to expect that an image taken in late Fall or at the onset of Winter would display plant life at least partially void of the foliage that would be present during warmer seasons. Such is shown in the images 100, 200 where, in the “before” image 100, stand of trees 110 is in full foliage, and in “after” image 200, the same stand of trees 110′ has lost its foliage for the season. Thus, as will be discussed hereinbelow, the physical change in the appearance of the stand of trees 110, 110′ is a periodic phenomenon, and would not be indicative of an unanticipated change by the method of the present invention. Moreover, as will be discussed further below, the data themselves will have supported the conclusion that the change in foliage of the stand of trees 110, 110′ was to be expected.

“After” image 200 displays several features which are obviously not the result of seasonal changes or even aging processes naturally associated to the passage of time. These features include a new road 230, a dam 210, and a reservoir of water 220. By analyzing the data collected prior to the acquisition of the “after” image 200, the method of the present invention would indicate that the new road 230, the dam 210, and the reservoir 220 are unanticipated changes and would be flagged as such.

“After” image 200 of FIG. 1B shows stream bed 130′ as being arid, perhaps due to dam 210. However, the data may show that stream 130 of “before” image 100 goes through seasonal fluctuations of relatively high flow during the warmer seasons and relatively low flow during the colder months. In such a case, the dried stream bed 130′ of “after” image 200 would not be flagged as an unanticipated change, because the data would have shown that the dryness of the river bed is a naturally occurring phenomenon for the time period at which the “after” image 200 was acquired. The same may be said for the group of plants 240. If the data show that the formation of plants 240 appear in later months of the year (as by, for example, maturation of the plant over the growing season), then the collection of plants 240 would not be flagged as an unanticipated change. On the other hand, if the plants 240 were planted in a fully grown state at some time between the acquisition periods of “before” image 100 and “after” image 200, then the group of plants 240 would be considered an unanticipated change and would be supported as such by the data.

The foregoing discussions of FIGS. 1A and 1B have illustrated several examples of image data that would be considered by the method of the present invention as an unanticipated change therein. An advantageous feature of the present invention is that the data are analyzed to determine what differences in the multi-dimensional data sets would constitute an unanticipated change. This is contradistinctive of methods of the prior art in which a user must introduce a priori parameters to a difference detection method to select unanticipated features. With this understanding, finer details of the method of the present invention may now be given.

Referring to FIG. 2, there is shown a first image 150 and a second image 160, which may correspond to “before” image 100 and “after” image 200, respectively. As is shown in the Figure, first image 150 is a composite of a plurality of image planes 150₁, 150₂, 150₃, . . . , 150_{N} and second image 160 is a composite of a plurality of image planes 160₁, 160₂, 160₃, . . . , 160_{M}. The values of N and M are determined by the imagery available. For example, given two Landsat™ images of the same location, taken at different times, then M=N=7, corresponding to the seven spectral bands of Landsat™ imagery. For the case of panchromatic imagery (a single one of a “before” and an “after” image), gives M=N=1. However, using a single value at a location of the first image and a single value for the same location of the second image is insufficient to make a determination as to the presence of an unanticipated change by means of the present method. Hence, the subject method is not limited to multi-spectral imagery; the necessary additional information per location of each image may come from multiple panchromatic images (either at different times or from different views) for both first and second images. It is also possible to use imagery of different types, such as a Landsat™ “before” image (N=7) in conjunction with panchromatic views as an “after” image (M=2).

Each image 150, 160 and its associated image planes, 150₁-150_{N}, 160₁-160 _{M} are composed of a plurality of locations l, each location being at spatial coordinates of the same point in the image. A collection of scalar quantities C_{B,1}-C_{B,N} representing each location l for each of the planes 150₁-150_{N} are assembled to form a vector 250 of scalar components. Similarly, a vector 260 is formed from the scalar quantities representative of the same locations l of the second image that were used to form the vector 250 of the first image. It is an advantageous feature of the present method that the vectors 250, 260 represent locations, not pixels. In a most basic configuration, a pixel could be used as a location. However, better results are achieved when the image resolution is relative to the size of an “interesting feature”. For example, if the goal of a particular image analysis is to find changes in permanent structures (e.g., roads, buildings), a typical feature is roughly 10 meters in the smallest dimension and an image resolution corresponding to such would be chosen. If a vehicle in an unusual place, say, the middle of a field, is considered interesting, the feature size would be roughly 2 meters and the corresponding image resolution would be selected. The change detection process of the method of the present invention performs optimally when the chosen size of a location is roughly one-third to one-half the smallest dimension of a feature.

A primary difficulty in layered-imagery analysis is the need for image registration. To build a vector for a location, that location must be identified on all of the image planes on all of the images. This will generally require warping the images and associated image planes to a common standard orthorectification. This is a non-trivial task especially to achieve pixel-level matching in images. However, as will be discussed in paragraphs below, pixel-level resolution is not a requirement of the present method. Registration is only needed to within a few pixels, based on the size of a location or feature. The ability to work with poorer than pixel-level registration is an advantageous feature of the method of the present invention, as previous studies of prior art methods have shown accuracy losses of 50% with less than 1 pixel mis-registration.

There are several known methods for the orthorectification of images. One exemplary method involves selecting several pairs of points in two images or image planes that correspond to the same actual spatial coordinates or image planes. The images or image planes are then scaled so that these points correspond to the same pixels, stretching and contracting, interpolating and decimating intermediate points accordingly. Automated orthorectification techniques use similar scaling, but automatically match features (such as lines) instead of relying on manual selection of points. As these methods are well-known in the art, they will not be discussed further here.

The meaning of change is subjective, making the methods for change detection difficult to define and evaluate. The implementation of the subject method defines change as follows: Given a set of component details D={d₁, . . . dₙ}, dᵢ ⊂ [symbol] and a set of location identifiers L ⊂ R an image is a set of vectors (l, C₁, . . . Cₙ) where l ∈ L and Cᵢ ∈ dᵢ. Given two images A and B, a vector pair is the vector (l, (C_{A,1}, . . . , C_{A,n}), (C_{B,1}, . . . C_{B,n})) where (l, C_{A,1}, . . . C_{A,n}) ∈ A and (l, C_{B,1} . . . , C_{B,n}) ∈ B. An unusually changed location lᵤ is a location where the vector (C_{A,1}, . . . C_{A,n}) is similar to the corresponding C_{A} vector in other vector pairs, but the (C_{B,1}, . . . C_{B,n}) vector is significantly different (or vice-versa).

As illustrated in FIG. 2, the change detection process of the present invention consists of several steps. The first step is to build several models, shown generally as vector prediction block 300, to predict the “after” vectors based on the “before” vectors. In an exemplary embodiment of the present invention, the models are artificial neural networks, trained on the location vectors previously discussed. A more complete description of the artificial neural networks and the training thereof is given below.

Once the models have been built, the “before” vectors are fed thereto to obtain predicted “after” vectors as indicated by arrow 170. The predicted “after” vectors for each location are used to construct a range of expected values for each component of the “after” image at that location. The same process is repeated, whereby “before” vectors are predicted by feeding the “after” vectors into artificial neural network models 300 to obtain an expected range for the “before” values based on the “after” values. The expected values for each vector component at each location is provided to change detection block 400, wherein the actual values (both “before” and “after”) are compared with the range of expected values for each location. If a significant number of the values are outside the range of expected values, the location is marked as a potential change. For each potential change, other potential changes are sought after in the surrounding locations. If a significant number of potential changes are found in the surrounding locations, the location is marked as an unanticipated change of interest. The set of unanticipated changes {l_{U}} 180 is produced as the output of the subject method.

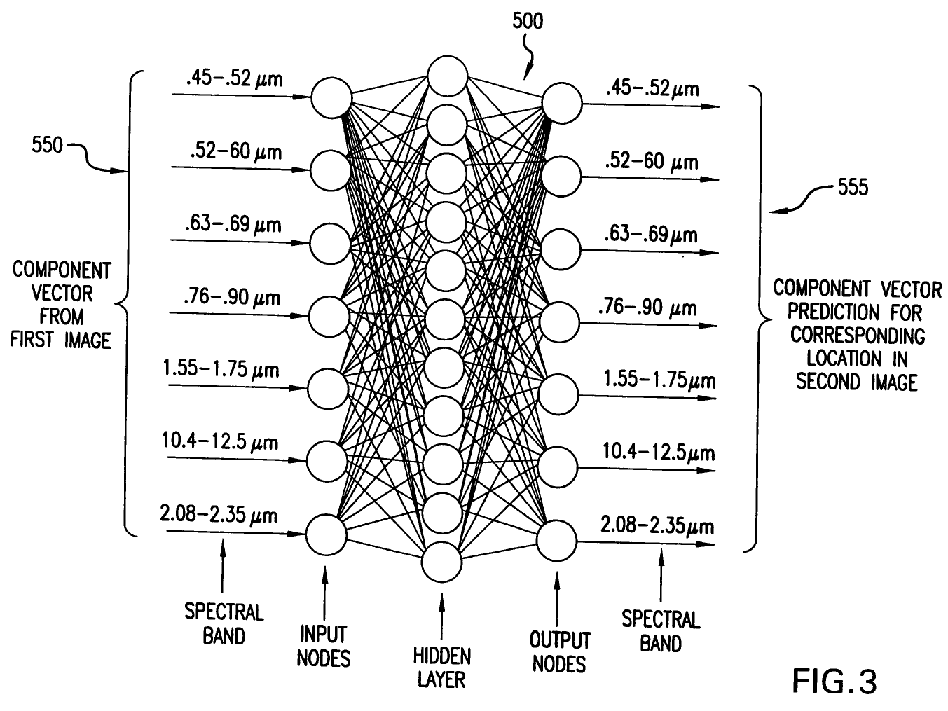

FIG. 3 is a functional diagram of an artificial neural network for use with Landsat™ spectral data and is illustrative of a typical vector prediction process 300 of the present invention. At the input of artificial neural network 500, there is applied a component vector 550 from the first image, such as image 150 of FIG. 2. Each component of vector 550 is a measured quantity from one of the spectral imaging bands of the Landsat™ imaging system and represents the scalar value at location l for each image plane. In some applications of the present method, each component of the component vector 550 would be an independent measurement of some physical quantity at a given location. The output of artificial neural network 500 is a predicted component vector 555 corresponding to the same location in the second image as was inputted from the first image. Note that in this example, the components of vector 555 correspond to the same components as input vector 550, since first and second images are composed of the same number of image planes (M=N). In other embodiments, vector 555 will have a different size than input vector 550. In all cases, vector 555 will have the same number of components as the second image.

In an exemplary embodiment of the present invention, each one of the set of the artificial neural networks of vector prediction process 300 is a three-layer sigmoidal neural network with the number of input nodes equal to the size of the “before” vector for a location and the number of output nodes corresponding to the “after” vector. The network includes a number of nodes in a hidden layer, the number of which grows as the size of the data set increases. The eleven nodes of the hidden layer of FIG. 3 is an appropriate number for a 10,000 location set of data. As the specific details of sigmoidal neural networks is well-known, a detailed description of the operation thereof will not be presented here.

As previously stated, one advantageous feature of the present invention is that the artificial neural networks, when used as the prediction model, are trained on the data set under evaluation. This eliminates the need for providing separate training data and, as previously suggested, allows the method of the present invention to identify unanticipated changes in data without any prior knowledge as to what an unanticipated change might entail. The training of the artificial neural networks will be discussed further below.

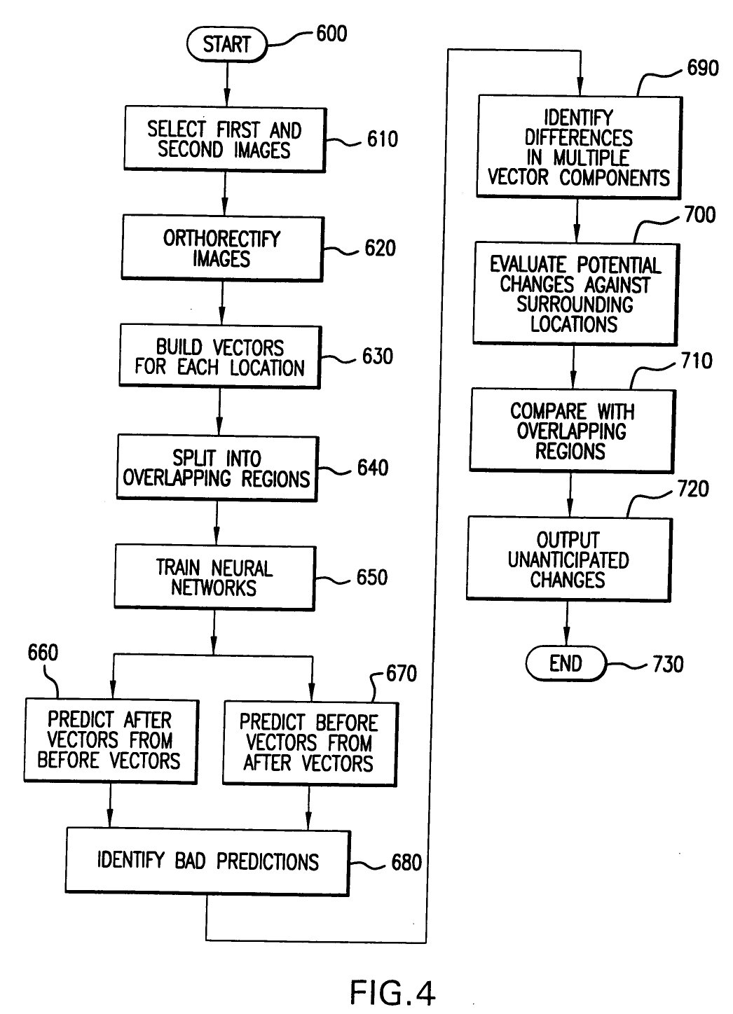

A flow chart illustrating the significant steps of the method of the present invention is illustrated in FIG. 4. As is shown in the Figure, the process is entered at start block 600 and thereafter, flows transfers to block 610 where first and second images are selected from the set of available images. The first and second images may be referred to as “before” and “after” images, respectively, when the data set, i.e., the set of available images, is correlated by time. The imagery to be used for “before” and “after” time periods would be selected to set the time range of interest, i.e., the time span of a particular study represented by the set of “before” and the set of “after” images over which the unanticipated changes in the images are relevant.

Once the first and second images have been selected, the process flow is transferred to block 620 where, first, a resolution is chosen based on the type of analysis being conducted, i.e., the minimum size of an “interesting” feature. As previously indicated, the resolution should be one-third to one-half the minimum dimension of the feature of interest. Upon selecting a resolution, the imagery is then orthorectified to within the chosen resolution. For example, if the resolution is 10 pixels, orthorectification to within 5 pixels is adequate for the purposes of the method of the present invention.

Once the images have been orthorectified to within the desired resolution, process flow is transferred to block 630 where the component vectors representing each location are formed in the manner discussed above. In the case of spectrally separated component vectors, a single value for the location may be obtained by averaging the pixel values nearest the location for each image and for each spectral band within the image. For example, for a 10 pixel goal resolution, the surrounding 10×10 region may be averaged to obtain the value for the location in that band/image. Note that in some embodiments, the difference between the target resolution and the actual resolution may differ for different components of the vector.

Once the locations have been identified and the vectors built for each location, the locations are split into overlapping regions as indicated at process block 640. Placing the locations on overlapping regions avoids a primary problem that when a feature is unusual in one region, it may be common in a neighboring region. Such locality problems are handled by looking at overlapping regions. The change is deemed to be unusual or unanticipated if it is identified as a change in at least two of the four regions associated with a location.

Dividing the image into small regions overcomes several deficiencies of similar prior art systems. First, as the size of an image grows, so does the number of “training instances” for a neural network. Larger regions increase the diversity of training instances, substantially increasing the difficulty of developing an adequate model relating the “before” and “after” images. In addition to the increased training time, diversity can pose a logical problem. Two features may have the same “before” values, but different “after” values. An example would be an ocean, and a seasonal lake. By itself, the ocean is highly predictable; it will remain water. Likewise, a seasonal lake will go from water (in the wet season) to relatively uniform dirt (in the dry season). Depending on the relative sizes of the regions, such differences in normal change can pose two problems: (1) the smaller feature may be dominated by the larger, and deemed an unanticipated change; or (2) the two features may be deemed “unpredictable” (some of the neural networks of the prediction model predict one, some of the neural networks predict the other, giving a wide range of possible values). The result would be to miss truly unusual features (e.g., a building appearing in the middle of a lake).

As the discussion with respect to FIGS. 1A and 1B revealed, the human definition of what is considered interesting can vary as well. A source of water disappearing, e.g., the river bed 130′ drying up because of dam 210, would probably be of interest. However, river bed 130′ being dry due to a naturally occurring seasonal phenomenon would not be.

The solution to the above-identified problems is to look for changes relative to a small region. To that end, the images are partitioned into small regions which are chosen to overlap neighboring regions. Inter-regional differences can be detected by, for example, differencing overlapping regions. Based on the assumption that a region is relatively homogeneous, an anomaly encountered on a global scale may be detected by this method. However, if it is considered usual for a region, it should be ignored.

Returning now to FIG. 4, once the overlapping regions have been identified, flow transfers to process block 650 in which the artificial neural networks are trained. Whereas, the training of artificial neural networks per se is well known in the art, the details thereof will not be discussed further here. However, the present invention uses the data under consideration as the training set, an exemplary implementation of which will now be discussed.

According to the exemplary training method, a neural network is first trained on one half of the data, using the other half as an evaluation hold-out set. The minimum error achieved on the hold-out set is used as a target error for the model. The model is then trained on the entire set until the target error is reached. The training of the neural networks using actual image data will now be described in detail.

In an exemplary embodiment of the present invention, the target training error is determined by first randomly dividing the available data into equal-sized training and hold-out sets. Next, an artificial neural network, e.g., a three-layer sigmoidal neural network as illustrated in FIG. 3, is constructed with the number of input nodes equal to the size of the “before” vector for a location and output nodes corresponding to the “after” vector. As is typical of neural networks, transmission of a data signal is controlled by an adaptive weighing function at each node. In an exemplary embodiment of the subject method, the initial weights in the network are seeded with random values and the artificial neural network is subsequently trained on the training set by any one of several known training methods, until the root mean squared error between the output of the method responsive to the “before” vectors of the hold out set being inputted to the neural network and the “after” vectors of the hold out set is minimized.

In one embodiment of the subject method, the target training error determination procedure is repeated for 2n epochs, where n is the epoch where the minimum error on the hold out set was found. This allows the algorithm to train past a local minimum.

Once the target training error has been determined, the minimum error is saved and the target training error procedure is repeated several times. The saved minimum errors are averaged to obtain a target training error.

After a target training error has been established, the network is trained on the entire data set. The training of the neural network is continued until the error (on the entire data set) equals the target training error previously determined.

The training technique described herein is one which avoids over-specificity and obtains a final network that can be expected to generalize its predictions. Over-training would, in theory, result in a network capable of predicting every value in the training set, which results in all network output being “anticipated”. By training the artificial neural networks over several training instances, each training instance initialized by randomly seeding the nodes of the neural network, the method of the present invention provides a network that can be expected to generalize or equate imagery with similar characteristics.

The artificial neural networks give a single set of output values (predictions) for each set of input values. However, some features are more varied in their changes than others. A deciduous forest may go from green in the summer to red and yellow in the fall, while a farm field goes from a uniform green to uniform brown. To capture the variation, a range of expected output values (predictions) is obtained by training multiple neural networks. The process described above is repeated, using different random values to seed the network each time, to give several predictions for each location. For spectral values corresponding to terrain where the changes are consistent, such as water or pavement, their predictions from the networks will be close to each other. However, for spectral values corresponding to difficult-to-predict terrain (such as plowed fields, that may have different types of crops in later pictures), the predictions from the separate networks are likely to be farther apart. Since each network starts with a different set of random weights, and stops at a local minimum, the networks may not reach the same local minimum for spectral values which are difficult to predict. The range of predictions produced by the multiple neural networks is used to automatically vary a threshold for declaring an unusual change based on terrain type, without any preconceived notion of terrain type.

Upon completing the training of the artificial neural networks, flow is transferred to blocks 660 and 670, wherein a set of “after” vectors is predicted from the “before” vectors and a set of “before” vectors is predicted from the “after” vectors using the model of the artificial neural networks. As previously discussed, the vectors produced from the artificial neural network are used to construct a vector of expected values for each component of the “after” image at each location.

Once the range of values for each vector component of each location has been acquired from the artificial neural networks, a prediction error is calculated for each component of each location. The prediction error is defined as the difference between the actual value and the average prediction value divided by the difference between the high and low predictions. For each component, the average and standard deviation of the prediction error is taken over all locations and stored for determining anomalies in the predictions.

In block 680, the prediction anomalies are identified from the predicted range of values. A prediction anomaly is defined as the location component where the prediction error is greater than the average error plus k×the standard deviation of error for that component. The value k can be adjusted. The results are not too sensitive to this parameter, however, adjustment can be made to give best results for the type of imagery used and analysis being conducted. Increasing k results in only more extreme changes being flagged as unusual.

The next step, as indicated by process block 690, is to look for corroborating evidence of potential changes. Corroboration may be established by examining changes in multiple vector components, i.e., changes on multiple image planes, for each location. In one embodiment of the present invention, one third of the components for a location resulting in a prediction anomaly is used to indicate a potential change. This value can be adjusted to fit the needs of the particular analysis and is most dependent on the type of imagery being considered. For example, in multi-spectral imagery, a low value would be more effective in detecting camouflage changes; the camouflage may prevent detection in most, but not all, spectral values. Note that predictions for each component of the “after” values based on the “before” values, and “before” values based on the “after” values are evaluated at each location.

The next form of corroborating evidence, as indicated at block 700, is to evaluate the potential changes at a location against those of surrounding locations. Here the requirement is that at least two thirds of the locations in a 3×3 neighborhood, for example, need to be flagged as potential changes for the center point of the location to be considered a change. Again, this is an adjustable parameter. Adjustments here affect primarily the size of unusually changed features that will be discovered. A 3×3 neighborhood finds features of size at least 6 pixels. For manmade features, using small neighborhoods and decreasing resolution (increasing pixel size) gives better results and faster computation than using a large region at full image resolution. A larger neighborhood may be appropriate for changes that are of varying size, e.g., scatter damage or diseased plants in a field where the entire field is the “feature”.

The three parameters used to determine unanticipated or unusual changes based on the neural network predictions are summarized in Table 1.

TABLE 1
Parameters for determining unusual change.

| Value | Calculation | Default parameter |
|---|---|---|
| Prediction Anomaly | Distance between | k = 4 |
| | prediction and value for a | |
| | particular component. | |
| | Distance must be greater | |
| | than average error + k* | |
| | standard deviation of | |
| | error, where average and | |
| | standard deviation are | |
| | based on errors for that | |
| | component in the image | |
| | pair. | |
| Component agreement | Number of components | ⅓ of components |
| | that must have prediction | |
| | anomalies to be | |
| | considered a changed | |
| | location. | |
| Surrounding changes | Number of surrounding | 5 of the 8 immediate |
| | locations that must be | neighbors |
| | changed to consider a | |
| | location as having an | |
| | unusual change | |

The default parameters of Table 1 are non-limiting examples that were chosen based on empirical study. The effectiveness on widely different types of imagery has shown that the defaults are adequate choices. One advantageous feature of the present invention is that these parameters are applied after the computationally intensive part of the process (the vector prediction process), and thus could be adjusted interactively by a user to obtain results appropriate to the user's particular task.

Each of the locations identified as “changed” by the method of the present invention are input to process block 710 where those locations so identified are compared with in the overlapping regions. The overlapping regions were formed by the method of the present invention in block 640. As previously discussed, a change is deemed to be unusual or unanticipated if it is identified as a change in at least two of the four regions overlapping the location of interest.

The locations identified in block 710 are marked as unanticipated changes and are output as such, as indicated by block 720. The unanticipated changes may be overlaid on the applicable image by, for example, a bounding box. Once the unanticipated changes have been identified and output, the process ends as indicated by the end block 730.

Although the present invention has been described herein in conjunction with specific embodiments thereof, many alternatives, modifications, and variations will be apparent to those skilled in the art. The present invention is intended to embrace all such alternatives, modifications, and variations that fall within the spirit and broad scope of the appended Claims.

1. A method for detecting unanticipated changes in a multidimensional data set comprising the steps of:
(a). selecting a subset of the multidimensional data set, each data set of said subset being correlated with the remaining data sets thereof by at least a predetermined criterion;
(b). partitioning each data set of said subset into a plurality of locations, each of said plurality of locations sized in accordance with a size parameter of known features of the multidimensional data sets;
(c). assigning a vector to each of said plurality of locations in each data set of said subset, said vector including a plurality of scalar components;
(d). estimating from at least one of said data sets of said subset at least one expected vector for each of said plurality of locations;
(e). calculating a vector of expected ranges for each of said plurality of locations from said at least one expected vector; and,
(f). comparing a vector assigned to each of said plurality of locations of at least one of said data sets of said subset to said vector of expected ranges corresponding to said each of said plurality of locations and identifying a location as including an unanticipated change when a predetermined number of said scalar components of said vector assigned to each of said plurality of locations exceeds said expected range in said corresponding vector of expected ranges.

2. The method for detecting unanticipated changes in a multidimensional data set as recited in claim 1 further including the step of providing a plurality of artificial neural networks, each of said plurality of artificial neural networks providing one of said at least one expected vector at an output thereof responsive to a vector assigned to one of said plurality of locations applied to an input thereof.

3. The method for detecting unanticipated changes in a multidimensional data set as recited in claim 2, further including the step of training said plurality of artificial neural networks on said subset of the multidimensional data set.

4. The method for detecting unanticipated changes in a multidimensional data set as recited in claim 3, wherein said training of said artificial neural networks includes the steps of:
(1). dividing said subset into a training subset and an evaluation hold out subset;
(2). initializing each node of said artificial neural network with a random value;
(3). training each of said plurality of artificial neural networks on said vector assigned to each of said plurality of locations of said training set according to a predetermined training method;
(4). applying said vector assigned to each of said plurality of locations of said evaluation hold out subset to said input of each of said plurality of artificial neural networks;
(5). computing an error function on a difference between each of said vectors assigned to each of said plurality of locations of said evaluation hold out subset and said corresponding estimated vector; and
(6). repeating said steps (2)-(6) until said error function is minimized.

5. The method for detecting unanticipated changes in a multidimensional set as recited in claim 4, where said error function is a root mean squared error function.

6. The method for detecting unanticipated changes in a multidimensional data set as recited in claim 2, wherein said estimating step (d) includes the steps of:
(1). dividing said subset into a first subset and a second subset;
(2). applying said vector assigned to each of said plurality of locations of said first subset to said input of each of said plurality of artificial neural networks for providing thereby a corresponding one of said at least one expected vector at said output thereof.

7. The method for detecting unanticipated changes in a multidimensional data set as recited in claim 6, wherein said calculating step (e) includes the step of calculating said vector of expected ranges from said plurality of scalar components of said at least one expected vector output from each of said plurality of artificial neural networks.

8. The method for detecting unanticipated changes in a multidimensional data set as recited in claim 7, further including the step of applying said vector assigned to each of said plurality of locations of said second subset to said input of each of said plurality of artificial neural networks for providing thereby one of said at least one expected vector at an output thereof.

9. The method for detecting unanticipated changes in a multidimensional data set as recited in claim 8, wherein said calculating step (e) includes the step of calculating said vector of expected ranges from said plurality of scalar components of said at least one expected vector corresponding to said first subset applied to said input of said plurality of artificial neural networks and from said plurality of scalar components of said at least one expected vector corresponding to said second subset applied to said input of said plurality of artificial neural networks.

10. The method for detecting unanticipated changes in a multidimensional data sets as recited in claim 1, wherein one of said at least one predetermined criterion with which each data set of said subset is correlated is time.

11. The method for detecting unanticipated changes in a multidimensional data set as recited in claim 1, wherein each of said plurality of scalar components is a measurement of a physical quantity corresponding to each of said plurality of locations.

12. The method for detecting unanticipated changes in a multidimensional data set as recited in claim 11, wherein said measurement of said physical quantity for each of said plurality of scalar components in each vector assigned to each of said plurality of locations is independent of said measurement of said physical quantity for remaining ones of said plurality of scalar components in said vector.

13. The method for detecting unanticipated changes in a multidimensional data set as recited in claim 1, wherein said partitioning step (b) includes the step of sizing each of said plurality of locations to be one-half to one-third said size parameter of said known features.

14. The method for detecting unanticipated changes in a multidimensional data set as recited in claim 1 further including the step of orthorectifying each data set of said subset so that features of each data set are sized in accordance with said size parameter.

15. The method for detecting unanticipated changes in a multidimensional data set as recited in claim 1, wherein each data set of said subset includes at least one image of pixels, said pixels representing said scalar components and grouped to form said locations.

16. The method for detecting unanticipated changes in a multidimensional data set as recited in claim 1, including the step of excluding a location from being identified as including the unanticipated change if less than a predetermined number of locations adjacent thereto are identified as including the unanticipated change.

17. A method for detecting unanticipated changes in a set of images, each of the set of images including a plurality of pixels, the method comprising the steps of:
(a). correlating the set of images by at least one predetermined criterion;
(b). grouping a predetermined number of adjacent ones of the plurality of pixels into a plurality of locations;
(c). assigning a vector to each of said locations, each vector including a plurality of scalar components;
(d). providing at least one artificial neural network for predicting, in accordance with said correlation by said at least one predetermined criterion, a vector for each of said plurality of locations from a vector of a corresponding location in a subset of the set of images;
(e). training said at least one artificial neural network on the set of images;
(f). predicting a first expected vector by each of said at least one artificial neural network for each of said plurality of locations from a first subset of the set of images;
(g). predicting a second expected vector by each of said at least one artificial neural network for each of said plurality of locations from a second subset of the set of images;
(h). computing, from said first expected vector from said each of said at least one artificial neural network and said second expected vector from said each of said at least one artificial neural network, a vector of expected ranges for each of said plurality of locations;
(i). computing a weighted vector of scalar components from said first expected vector from each of said at least one artificial neural network for each of said plurality of locations; and
(j). comparing said weighted vector to said vector corresponding to said location in said second subset of the images and identifying differences therebetween as unanticipated changes when said differences exceed said expected range in said corresponding vector of expected ranges.

18. The method for detecting unanticipated changes in a set of images as recited in claim 17, wherein said training of said artificial neural networks includes the steps of:
(1). dividing the set of images into a training subset and an evaluation hold out subset;
(2). initializing each node of said artificial neural networks with a random value;
(3). training each of said artificial neural networks on said vector assigned to each of said plurality of locations of said training subset according to a predetermined training method;
(4). applying said vector assigned to each of said plurality of locations of said evaluation hold out subset to said input of each of said plurality of artificial neural networks;
(5). computing a root mean squared error function on a difference between each of said vectors assigned to each of said plurality of locations of said evaluation hold out subset and said corresponding estimated vector;
(6). repeating said steps (2)-(5) until said root mean squared error function is minimized; and
(7). training each of said plurality of artificial neural networks on said vector assigned to each of said plurality of locations of said set of images according to said predetermined training method.

19. The method for detecting unanticipated changes in a set of images as recited in claim 17, wherein said at least one predetermined criterion with which set of images is correlated is time.

20. The method for detecting unanticipated changes in a set of images as recited in claim 17, wherein each of said plurality of scalar components is a measurement of a physical quantity corresponding to each of said plurality of locations.

21. The method for detecting unanticipated changes in a set of images as recited in claim 17, wherein said grouping step (b) includes the step of sizing each of said plurality of locations to be one-half to one-third said size parameter of said anticipated features.

22. The method for detecting unanticipated changes in a set of images as recited in claim 17 further including the step of orthorectifying each subset so that features of each data set are sized in accordance with said size parameter.
